(19) United States
(12) Patent Application Publication
(10) Pub. No.: US 2015/0046424 A1
(43) Pub. Date: Feb. 12, 2015

(54) Methods and systems for searching software applications

(71) Applicants: Hsiu-Ping Lin, Taipei (TW); Chi-Jen Wu, Taipei (TW)

(72) Inventors: Hsiu-Ping Lin, Taipei (TW); Chi-Jen Wu, Taipei (TW)

(21) Appl. No.: 14/258,016

(22) Filed: Apr. 22, 2014

Related U.S. Application Data
(63) Continuation of application No. 13/960,779, filed on Aug. 6, 2013.

(51) Int. Cl. G06F 17/30

(52) U.S. Cl. CPC G06F 17/30864; G06F 17/3053
USPC 707/708

(57) ABSTRACT

The present invention relates to methods and systems for searching software applications, including mobile applications (apps) and web apps/extensions/plug-ins (applications). The method comprises the steps of; executing at least one app or application, collection application data from the app or application, storing the collected application data, receiving a query, searching the stored application data, and transmitting information regarding apps or applications whose corresponding stored application is relevant to the query.

### CROSS-REFERENCE TO RELATED APPLICATION(S)

The application is a continuation of U.S. application Ser. No. 13/960,779, filed on Aug. 6, 2013, which claims priority to U.S. Provisional Application No. 61/679,948, filed on Aug. 6, 2012, entitled “METHODS AND SYSTEMS FOR SEARCHING APPLICATIONS,” which is incorporated by reference herein in its entirety.

### TECHNICAL FIELD

The present invention relates to software applications. Particularly, the present invention relates to systems and methods of providing search engine services to locate the desired software applications.

### BACKGROUND

Search engines are important tools for people to search information online. Also, mobile applications (hereinafter referred as “app or apps”) have become popular due to the widespread use of smartphones. Today, apps are either preloaded in the mobile devices or can be downloaded from the Internet. Popular apps such as Facebook, Twitter, Angry Birds, WhatsApp Messenger and Google Maps garner more than hundreds of millions of downloads worldwide. Application distribution platforms such as Apple's “APP store”, Google's “Google Play”, Tencent's “bao.myapp.com” and the Taobao's “app.taobao.com” (hereinafter referred as “App Stores”) allow users to browse and download apps of their interests. An App Store typically organizes apps into categories and provides conventional search utilities to allow users to find desired apps by key word search. Such conventional search utility in an App Store looks into an app's title and description, which are usually prepared by the app developer, for a match with the keywords entered by a user. Some App Stores even provide web interfaces, such as “Edit Application” in Google Play and “Manage Your Apps” in Apple's App Store, that allow developers to upload and edit the titles and descriptions of their apps.

When executed, apps generate data (hereinafter referred as “application data”) which can be dynamic in nature in addition to static data. Specifically, when an app is running on a mobile device, the app generates application data depending on various triggers, such as but not limited to behavior of the app user. For example, if a user wants to check the weather forecast using a weather app, the user can input his/her location of choice in the app interface. The weather app will deliver the relevant application data, in this case the weather forecast of the user's location. In other words, application data can be dynamic based on user's operation of the app. The application data can either be sourced from one or more application servers associated with the app or created by the app itself.

As stated above, conventional search utilities found in the App Stores are limited to keyword search of title and description of the apps only. Therefore, the scope of the search does not extend to application data. In other words, conventional search utilities can neither search “into” an application package file relating to the app (e.g., an apk file or an ipa file), nor can it search the application data generated after the application package file is being or has been executed on a user's electronic device. Rather, search utilities available today can only search static information provided by the application developers such as title and description of the application. Application data as described above, is, therefore, not currently searchable because it is not in the description or title of the app. This means that application data generated by the app in response to a user's command of the app may never be found or searched by another user who may find such information valuable.

In addition to apps that are installed in the mobile devices, web apps, extensions and plug-in that can run on electronic devices such as a desktop or laptop computer (hereinafter referred as “applications”) also became very popular due to ubiquity of web browsers. Examples of web apps include Google's “Google Docs,” Microsoft's “Office Web Apps” and all the webmail services on the Internet. Popular extensions include “Chrome Extensions,” “Safari Extensions” and “Firefox Add-ons.” Plug-ins such as “Java applet”, “Adobe Flash Player” and “Quick Time Player” are also widely distributed and used. A client, while using these applications on a computer, in effect, constantly communicates with remote application servers associated with these applications to complete his/her tasks. Much like how apps request information from their corresponding application servers, applications operating on computers also generate significant amount of data that can be tremendously valuable.

### BRIEF SUMMARY

The present invention relates to methods and systems for searching software applications. Specifically, the present invention allows a user to conduct search for software applications by searching application data, or data generated by the execution of software application. Application data includes but is not limited to characters, attributes, descriptions, serial numbers, identifiers, statistics, historical records, hyperlinks, file paths, audio, video, any other information in searchable formats and any combination thereof.

In one embodiment, the invention provides a method for searching for apps by searching corresponding application data. The method includes executing at least one app. As part of executing the app, the app generates application data. This application data comprises data received from corresponding application server and/or data created by the app itself. The application data is then collected and stored. A query is received. A search on the stored application data is performed to look for application data relevant to the query. If application data is relevant to the query, information regarding the apps with the relevant application data is transmitted.

In another embodiment, the invention provides a method for searching for apps by searching application data. The method includes executing at least one app on a virtual machine. Application data produced by the app is then organized into categories. The categorized application data is stored in a database. A user query is received. The database storing the application data is searched according to the query. Ranking the searched application data by relevance to generate a ranked result is performed. The ranked result is transmitted to the user.

In another embodiment, the invention provides a method for searching for applications (i.e., web app, extensions and plug-ins) by searching application data. The method includes executing at least one application. As part of executing the application, the application generates application data. This application data comprises data received from corresponding application server and/or data created by the application itself. The application data is then collected and stored. A query is received. A search on the stored application data is performed to look for application data relevant to the query. If application data is relevant to the query, information regarding the applications with the relevant application data is transmitted.

In another embodiment, the invention provides a method for searching for applications by searching application data. The method includes executing an application on a virtual machine. Application data produced by the application is then organized into categories. The categorized application data is stored in a database. A user query is received. The database comprising the application data is searched according to the query. Ranking the searched data by relevance to generate a ranked result is performed. Then the ranked result is transmitted to the user.

In another embodiment, the invention provides a method for searching apps or applications. The method includes collecting data from at least one application server. The data from the application server is then stored. A user query is received. Searching is performed to identify data that is relevant to the query. Information regarding apps or applications with data relevant to the query is transmitted. Here, data can be collected continuously or periodically.

In another embodiment, the invention provides a method for searching apps or applications. The method includes implementing a program to direct the application server to transfer data. The transferred data is collected and stored in a database. A user query is received. Searching of the database is performed. Information regarding apps or applications with data relevant to the query is transmitted. The data can be transferred from the application server to the database continuously or periodically.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings examples which are presently preferred. It should be understood, however, that the present invention is not limited to the precise arrangements and instrumentalities shown.

In the drawings:

FIG. 1 is a conceptual diagram illustrating a networked system for searching apps or applications based on application data according to an embodiment of the present invention;

FIG. 2 is a diagram illustrating a networked system for searching apps or applications based on application data according to an embodiment of the present invention;

FIGS. 3A and 3B are diagrams illustrating data structures according to an embodiment of the present invention;

FIGS. 3C and 3D are diagrams illustrating data structures of a logical table and a row of it according to an embodiment of the present invention;

FIG. 4A is a diagram illustrating a networked system for searching apps or applications based on application data according to an embodiment of the present invention;

FIG. 4B is a diagram illustrating a networked system for searching apps or applications based on application data according to an embodiment of the present invention;

FIG. 4C is a diagram illustrating a networked system for searching apps or applications based on application data according to an embodiment of the present invention;

FIG. 4D is a diagram illustrating a networked system for searching apps or applications based on application data according to an embodiment of the present invention;

FIG. 4E is a diagram illustrating a system with data harvest framework according to an embodiment of the present invention;

FIGS. 5A to 5E are diagrams illustrating exemplary user interfaces of an app according to an embodiment of the present invention; and

FIGS. 6A to 6C are diagrams illustrating exemplary user interfaces of services provided by application search engines according to an embodiment of the present invention.

### DETAILED DESCRIPTION

Reference will now be made in detail to the examples of the invention, which are illustrated in the accompanying drawings. Wherever possible, the same reference numbers will be used throughout the drawings to refer to the same or like parts.

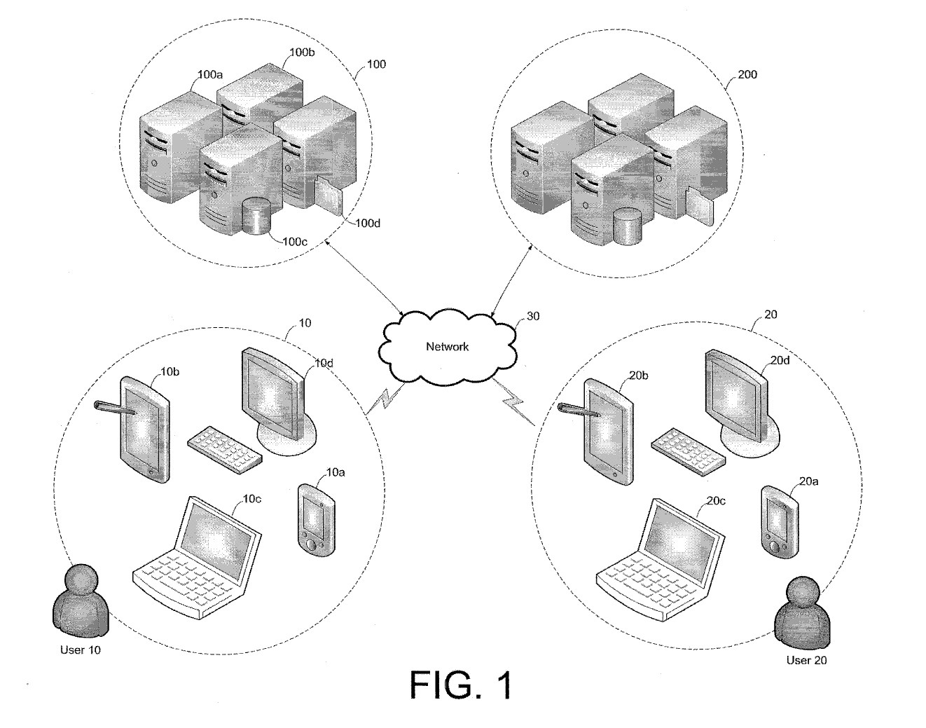

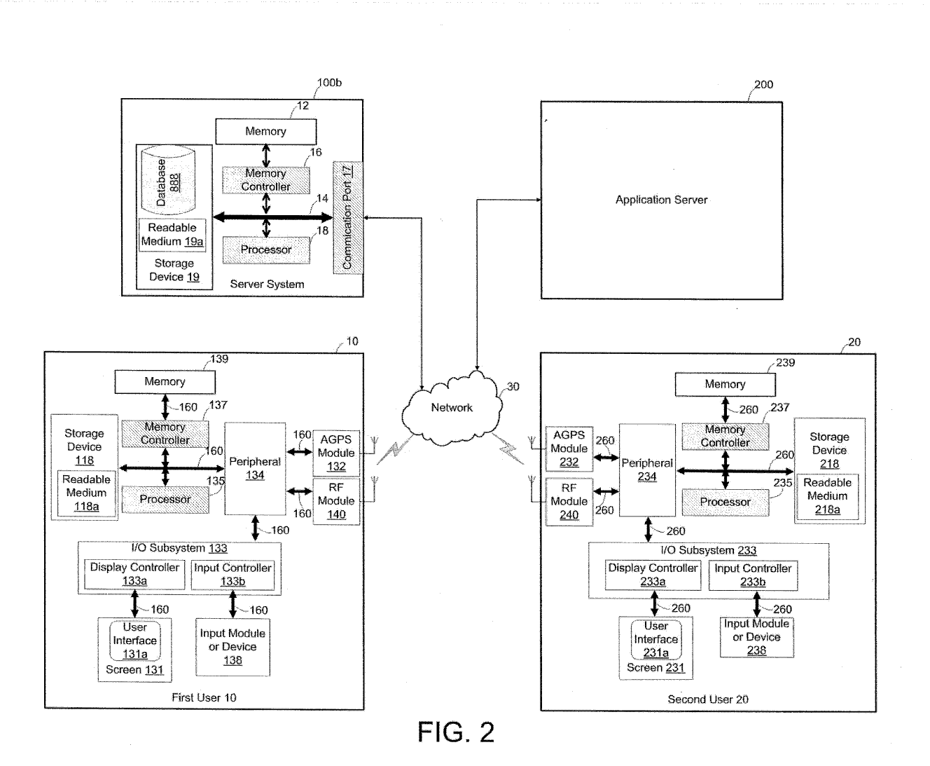

FIG. 1 is a conceptual diagram illustrating a system according to an example of the present invention. The system can include a server cluster 100 (or a cloud), application servers 200, a first user 10 and a second user 20, each of which can communicate with each other through network 30, which can be but not limited to the Internet or a cellular network. In this example, the server cluster can include a plurality of servers (e.g., servers 100a-100d shown in FIG. 1), each of which is configured to perform at least a part of the tasks, processes or steps of the present invention, either separately, sequentially, in parallel or a combination thereof to enhance the efficiency of the system. A server in the server cluster 100 can include but not limited to a processor, a memory, a communication port and a storage device such as a database. An example of the server cluster can be described with reference to FIG. 2. Here, a personal computer (PC) can also be used as a server in the server cluster 100.

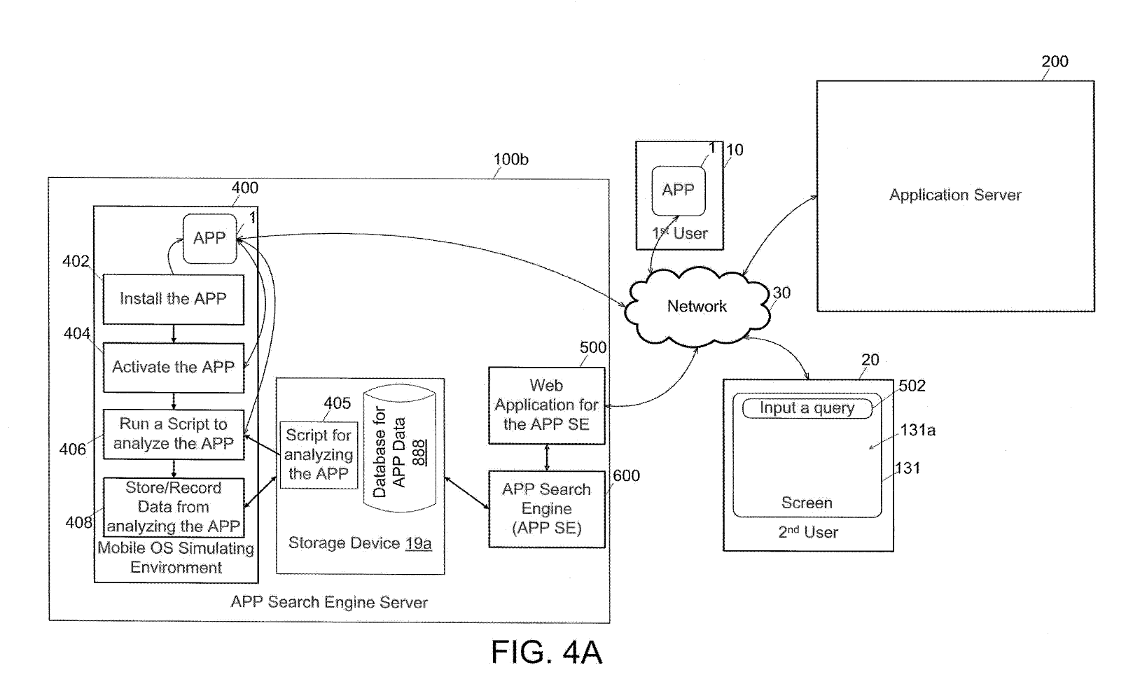

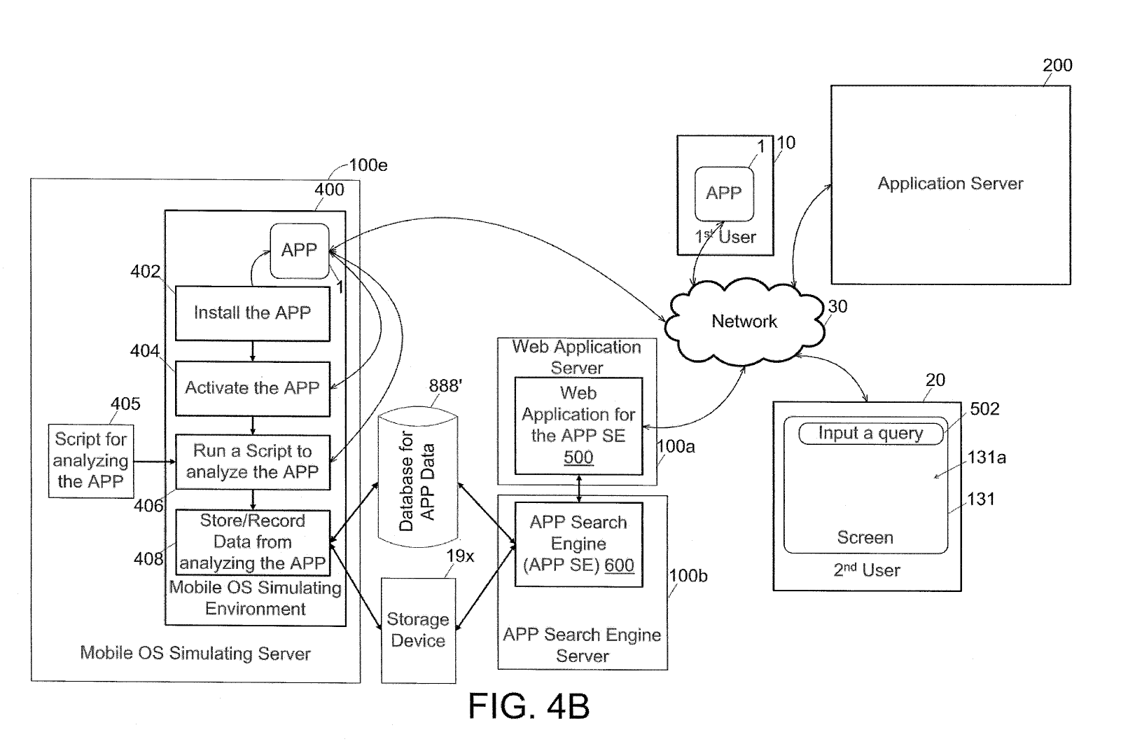

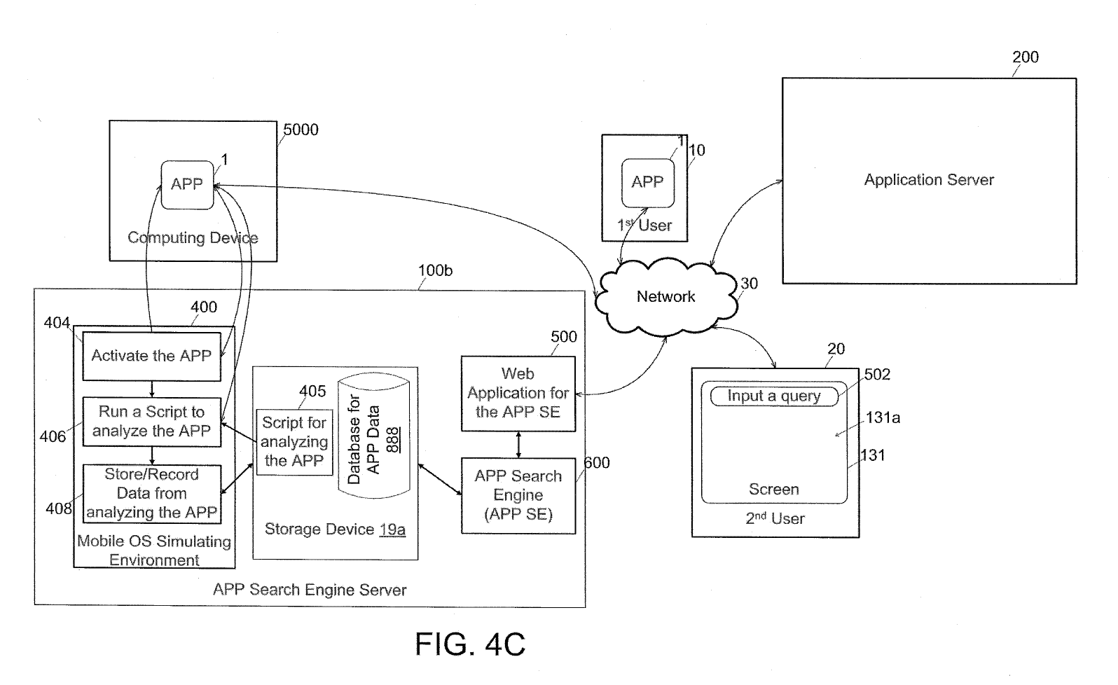

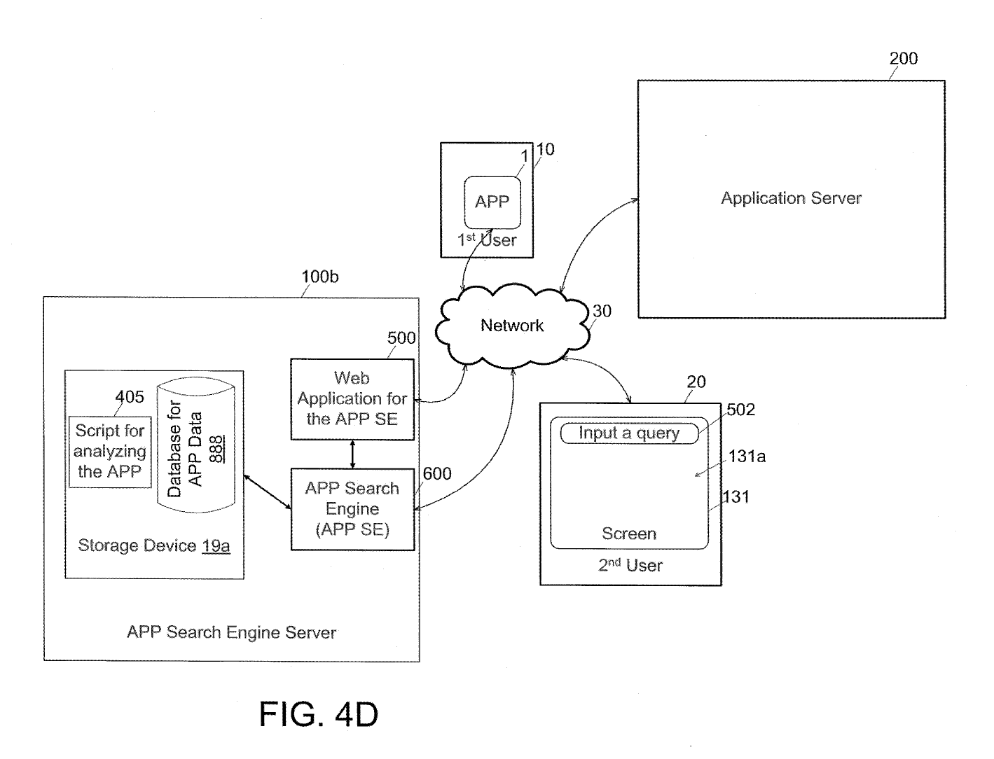

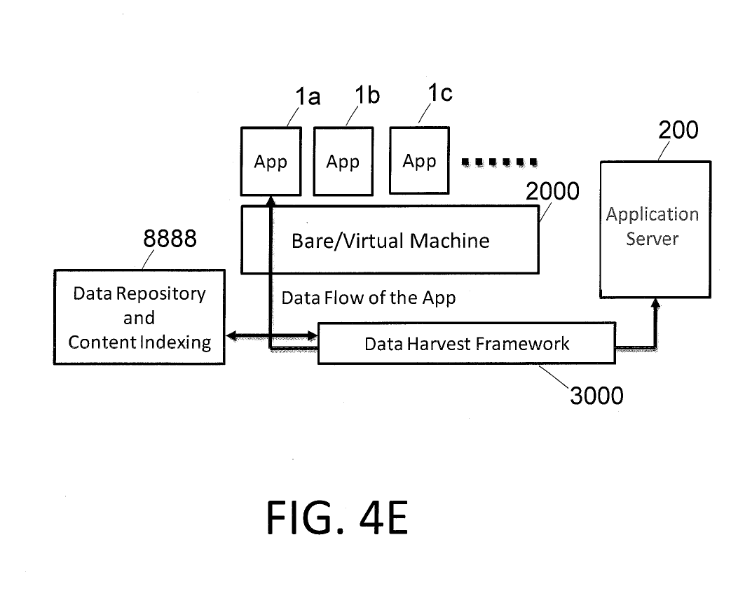

Referring to FIGS. 1, 4A and 4B, the server 100a can be configured as a web application server (hereinafter the “web application server 100a”) that couples to the server 100b (hereinafter the “application search engine server 100b”) to service the first user 10 and the second user 20. The primary function of a web application server 100a is to provide web related utilities to users. For example, web interfaces that allow users to input data search requests are provided by web application server 100a. The primary function of an application search engine server 100b is to provide search engine service to search application data. Note that application data can include but is not limited to characters, attributes, descriptions, serial numbers, identifiers, statistics, historical records, hyperlinks, file paths, audio, video, any other information in searchable formats and any combination thereof.

The web application server 100a can provide (or cause a web browser to show) a search field or a search button 502 on a screen 131 of the first user 10 or on a screen 231 of the second user 20 to allow access to the search utilities provided by the application search engine server 100b. A user can input a query through the search field to initiate a search. Those skilled in the art understand the query in this example can be in the form of one or more keywords, images, video streams, audio or a combination thereof. For example, a user can input a keyword into the search field 502 by typing one or more words or pronouncing the one or more words. In another example, the user can press the search button 502 to submit queries in image, video or audio format.

Refer to FIG. 4A, an app can be installed in the application search engine server 100b or first user 10. When the app is installed and activated (i.e., executed), the app can generate application data depending on how the app is operated. The application data can be provided by the application server 200 or created by the app itself. The application search engine server 100b subsequently collects such application data.

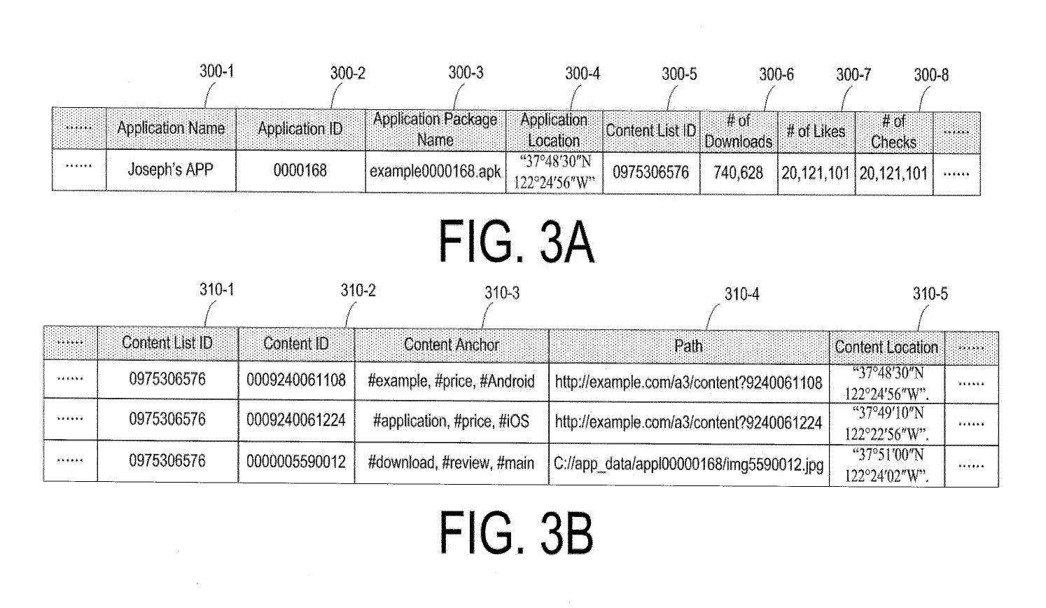

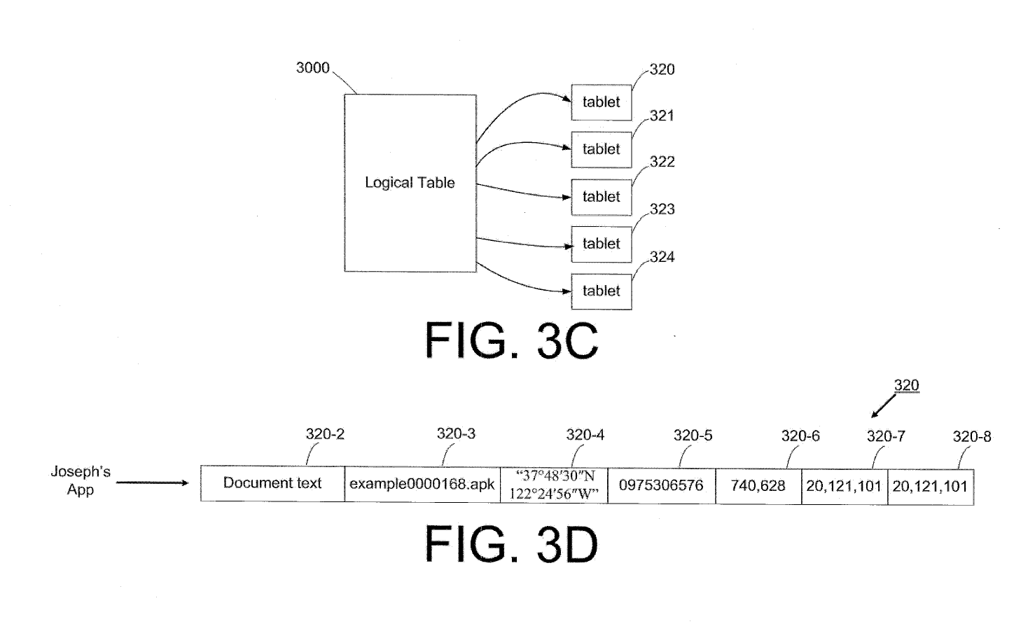

Refer to FIGS. 1 and 4A, application data can be stored in a database either in the web application server 100a or in the application search engine server 100b, as shown in FIGS. 2 and 4A. The application data can be stored as string(s) or binary code(s) in the database. The collected application data can be managed, accessed or queried by the web application server 100a or the application search engine server 100b with programming languages such as SQL, C, C++, or other data management tools. In one example, the string(s) or binary code(s) in the database can be searched based on a query. In another example, pieces of data stored in the database can be associated with one or more unique keys (e.g., a primary key), and specific pieces of data can be located by searching for one or more keys. Before being stored in a database, the application data can first be organized into a plurality of categories where each category is related to a plurality of keywords (e.g., keywords such as “hotel” and “lodge” are associated with the category “travel”). Then, data belonging to the same category can be stored corresponding with a group of keys having, for example, sequential or related numbers (or having specific numbers such as all even or all odd numbers, all starting/ending with a number like “1”, “2”, etc., or a specific bit/digit of all the numbers are “1”, “2”, etc.). When the application search engine server 100b searches for application data relating to a given query, the keys associated with the plurality of keywords that is associated such given query can be selected first. Subsequently, application data in the database that corresponds with the selected keys is searched for relevance to the query. Note that the collected application data can be stored and searched by using other search engine technologies. In one example, the application data can be stored in a logical table (e.g., BigTable) or a Hadoop file system (HFS) in Hadoop framework. FIG. 3C is a logical table 3000. FIG. 3D illustrates a row 320 of the logical table 3000. Here, application data can be stored in tablets 320-324 in a replicated file system that is accessible by all tablet servers (not shown, e.g., all BigTable tablet servers). Any changes to the tablets are recorded to a transaction log which is stored in a shared file system. In this example, the tablets 320-324 store data immutably (i.e., once the data is written to the logical table 3000, it is never changed). In another example, to allow for table updates, newer data can be stored in RAM, whereas older data is stored in a series of files in the logical table 3000.

In another example (referring to FIGS. 1 and 4B), the application data can be stored in a standalone database 888′. The database 888′ can be managed by the web application server 100a or the application search engine server 100b with programming language such as SQL, C, C++, or other data management languages or tools. Accordingly, the data stored in the database 888′ can be searched by the application search engine server 100b.

Those skilled in the art understand that either the web application server 100a or the application search engine server 100b can by itself provide the abovementioned search functions. Accordingly, web application and search function do not need to be implemented in two separate servers. Moreover, these functions can also be implemented in PaaS, IaaS or SaaS so there is no need to specify the number of servers or storages needed.

In other example (referring to FIG. 1), the server cluster 100 can further include a server 100c (hereinafter the “database management server 100c”) configured to either function as a first database, or to perform database management services to a second database (not shown) that couples to server 100C and is used to store application data. For example, the second database can exist in a storage area network (SAN) and the database management server 100c can control the second database in the SAN. The application data stored in the first or second database can be managed by programming language such as SQL, C, C++, or other data management tools (i.e., the first or second database can be controlled and accessed by the database management server 100c when the database management server 100c performs the method of the present invention).

In another example, if the application data is an image, a video, a voice/audio file or text, it can be stored in a storage device (not shown) of the web application server 100a, a storage device 19 of the application search engine server 100b (See FIG. 2), a storage device (not shown) of the server 100c (See FIG. 1), or a storage device 19x coupled to the server 100a or 100b or 100c (See FIG. 4B). A corresponding file name, title, description or anchor (see e.g., FIG. 3) of such data can be stored as a string(s) in the database of the web application server 100a, in the database of the application search engine server 100b or in the abovementioned first database or the second database to allow search.

In one example, each string(s) corresponding to the image, the video, the voice/audio file or the text can also have a file path stored in the database to indicate the location of the data. For example, the server cluster 100 can further include a server 100d (hereinafter the “file management server 100d”, see FIG. 1) that can couple to the servers 100a, 100b or 100c and perform file management services. A file with its string(s) matching the keyword will be presented as a search result. The file is retrieved via a path corresponding to its string(s) when the string(s) matching the keyword is found in the database.

Those skilled in the art understand that the server(s) 100a, 100b and/or 100c can also perform file management services to the storage (or the NAS).

In another example, a plurality of servers can be configured to work in parallel to scale up the server cluster 100 to provide services to a large amount of the clients in a network. Here, storage devices and databases coupled to the abovementioned server(s) could also be scaled up.

Moreover, data traffic into or services provided by the server(s) 100a, 100b, 100c and 100d can be controlled by a load-balance module or server (not shown). One skilled in the art understands that the method(s) of the present invention is not limited to the number of the servers in the server cluster 100.

In another example, a single server can be configured to perform all the tasks and processes on the server side of the network as shown in FIG. 1. Such a single server can replace the server cluster 100 if the application data amount is small and the tasks required to run by the server are simple.

It is also feasible that servers 100a to 100d can swap their roles dynamically. The servers in the server cluster 100 can swap the task(s), process(s) or step(s) among each other and still maintain the integrity of the system.

The first user 10 can operate either apps or applications running on a computing device to request data from the relevant application server or cloud. The computing device can be but not limited to a smart-phone 10a, a tablet (or a “pad”) 10b (collectively referred as mobile devices), a laptop 10c or a personal computer 10d, a television (TV, not shown), a personal digital assistant (PDA, not shown), a navigator (not shown, e.g., a GPS), a digital camera (not shown), a video camera (not shown), a projector (not shown), a portable media player (PMP, not shown), an electronic book (e-book, not shown), an information appliance (IA), a walk-man (not shown) or MP3 player (not shown), a TV game console (not shown), a handheld game player (not shown), an electronic dictionary device (not shown), a car computer (not shown) or a driving recorder (not shown). Similarly, a second user 20 can operate the same apps or applications in a computing device as described above. One skilled in the art understands that it is not necessary to have a human to operate the apps or applications in order to obtain application data. A machine, program or robot configured to automatically operate the apps or applications is also possible.

FIG. 2 illustrates a system with an application search engine server 100b system, an application server 200, a first user 10 and a second user 20. The application search engine server 100b system can include but not limited to a memory 12, a data path 14, a memory controller 16, a communication port 17, a processor 18 and a storage device 19. In one example, the storage device 19 can include a computer-readable medium (or a machine-readable medium) 19a. The computer-readable medium can be a magnetic disk, a card, a tape, a drum, a punched card, a paper tape, an optical disk, a barcode or a magnetic ink character. In another example, the storage device 19 can include a database 888. Note that the database 888 or the storage device 19 can also be configured to exist outside the server system but couples with the application search engine server 100b. In another example, a storage device(s) on the server cluster 100 (e.g., the storage device 19) can also be treated as a computer-readable medium.

The first user 10 or the second user 20 can each include a memory 139 or 239, a data path 160 or 260, a memory controller 137 or 237, a processor 135 or 235, a storage device 118 or 218, a peripheral 134 or 234, an AGPS (Assisted Global Positioning System) module 132 or 232, an RF (Radio Frequency) module 140 or 240, an I/O system 133 or 233 including a display controller 133a or 233a and an input controller 133b or 233b, a screen 131 or 231 including a user interface 131a or 231a, and an input module or device 138 or 238. In one example, the storage device 118 or 218 can include a computer-readable medium 118a or 218a respectively. In another example, the storage device 118 or 218 can also be treated as a computer-readable medium.

Apps or applications can be executed by the first user 10 to generate application data. The application data can be provided by the application server 200 or by the apps or applications. The application data is stored in the database 888. Second user 20 conduct a search via the user interface 231a. The Application search engine server 100b system conducts the search and transmits the search result to second user 20.

Those skilled in the art understand that the elements, modules or devices described in the systems above can be integrated into one module or a single chip. Moreover, the server system in the application server engine server 100b, the first user 10 and the second user 20 can couple to each other by the Internet or the cellular network 30. Furthermore, server system(s) in the server 100a, 100c or 100d can also include the same elements, modules or devices as those shown in FIG. 2.

### Database

FIGS. 3A and 3B illustrate data structures according to an example of the present invention. Referring to FIGS. 3A, 3B, 4A and 4B, application data can be stored in the database 888 or 888′ (or the storage device 19a on the application search engine server 100b or the storage device 19x existing inside or outside the file management server 100d). The database 888 or 888′ can be a relational database. Referring to FIG. 3A, the data structure can include a first field 300-1 to store the name of an app 1 (e.g., “Joseph's App”), a second field 300-2 to store the application ID used to identify app 1 (e.g., an application number assigned by the application search engine server 100b to identify data stored in the database 888 or 888′ that relates to app 1, which is “00000168” in this example), a third field 300-3 to store the file name of an application package of app 1 (e.g., “example0000168.apk”), a fourth field 300-4 to store the location of app 1 (e.g., a fixed or changing location where app 1 is set, such as a coordinate like “37° 48′30″N 122° 24′56″W”), a fifth field 300-5 to store the content list ID (i.e., an ID assigned to identify the list of content of app 1 referred in FIG. 3B), a sixth field 300-6 to store the number of downloads for app 1, a seventh field 300-7 to store the number of likes for app 1 (e.g., the number of times a “like” button is pressed by users to approving the content of app 1), and an eighth field 300-8 to store the number of check-in for app 1 (e.g., users executing app 1 to check-in to specific locations).

FIG. 3B represents one of the data structures for content list ID stored in 300-5 referred in FIG. 3A. The structure includes a first field 310-1 to identify content list IDs, a second field 310-2 to store all the content IDs corresponding to 310-1, a third field 310-3 to identify content anchors, a fourth field 310-4 to store file paths, and a fifth field 310-5 to identify content location.

Those skilled in the art understand that some fields shown in FIGS. 3A and 3B are optional. The data structure in database 888 or 888′ is not required to include the exact same fields as shown in FIG. 3A or 3B. Moreover, the logical table 3000 or the HFS can also be used to implement the database of the present system where each data in the HFS or the logical table 3000 is a key-value pair (or a key-data pair, where, e.g., the name of the App, “Joseph's App,” can be the key to the data in FIG. 3D).

### Application Search Engine

FIG. 4A illustrates a system for searching application data according to the present invention. The system can include the application search engine server 100b, application server 200, the first user 10 and an application server 200. The application server 200 communicates with app 1 to provide dynamic and/or real-time data in addition to static data. In this example, the application search engine server 100b can include a virtual machine 400, a web application 500, an application search engine 600 and the storage device 19a. The virtual machine 400 is an operating system (OS) simulating environment capable of hosting apps. In other words, apps can be executed on the virtual machine 400 similar to or just like how they are executed on a mobile device. Those skilled in the art can understand that a bare machine approach can also be applied for hosting apps in the server 100b or 100e. When applying the bare machine approach, a program (not shown) configured as an interface between the server 100b or 100e and the hosted apps can be used to translate system calls of the hosted apps into machine codes and directly feed the machine codes into the server 100b or 100e for dealing with all the communication between the server 100b or 100e (or the app server 200) and the hosted apps (e.g., sending a request, receiving application data, etc.). An application package for app 1 can be downloaded directly from the application server 200 or other data locations (not shown, for example, an application store/market such as the “APP Store” or the “Google Play”) that either store the application package or can provide a download link relating to the application package.

In one example, the virtual machine 400 can include a first module (or program) 402 configured to install an application package in the virtual machine 400. Here, the virtual machine 400 can further include a second module (or program) 404 configured to execute app 1. The second module (or program) 404 can either continuously or periodically execute app 1. In one example, if more than one apps are running on the virtual machine 400, the second module or program 404 can execute all the apps either sequentially, in random, or in parallel, depending on the policies and rules set in the second module 404.

In another example, the virtual machine 400 can further include a third module (or program) 406 configured to analyze the executed app 1. This module determines how app 1 communicates with application server 200. For example, the third module 406 can inspect the different functions that app 1 offers and how such functions can be activated to requests application data from the corresponding application server 200. Subsequent to such analysis, a script (405) can be programmed to automatically and systematically execute app 1 to generate application data. Another example is to integrate the third module 406 and script 405 by introduce an App robot capable of reviewing and executing apps on the virtual machines without any human interventions.

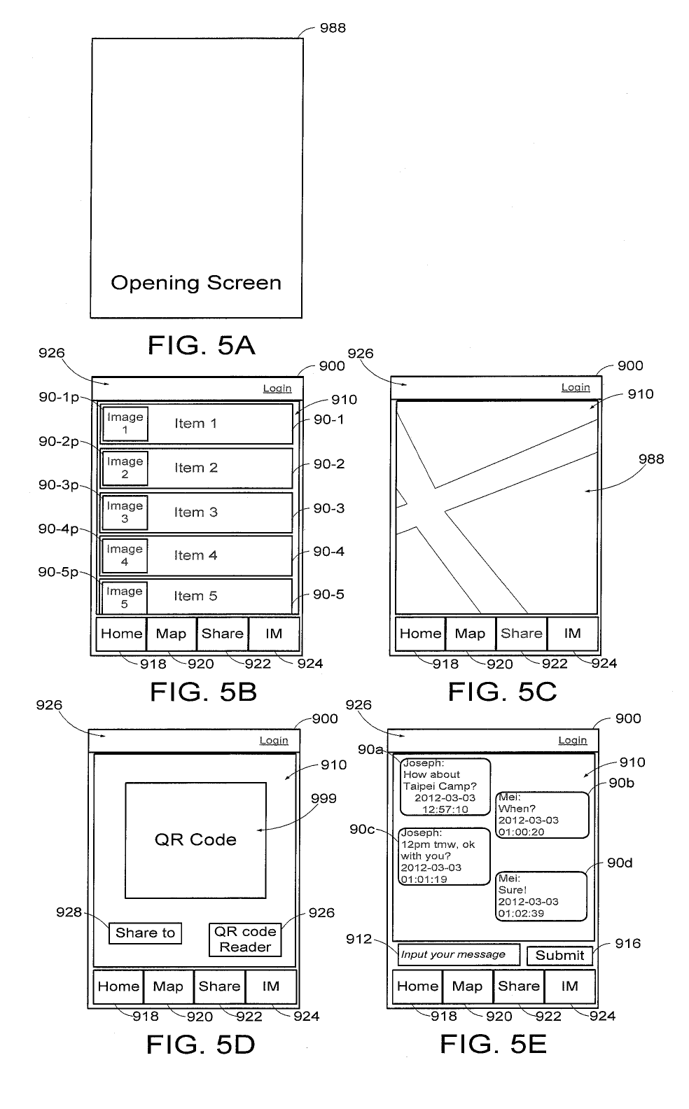

FIGS. 5A-5E are exemplary user interfaces for app 1. In one embodiment, app 1 provides a function to request data from its associated application server 200 by pressing or clicking the item 90-1, as shown in FIG. 5B. Here, the third module (or program) 406 can analyze the user interface to determine the locations and functions of the items 90-1 to 90-5. And a script 405 can be provided to simulate the behavior of an app 1 user, such as clicking the item 90-1, to request data from the application data 200. One example is to program the script 405 in the application search engine server 100b (or the third module (or program) 406) when third module (or program) 406 is analyzing app 1. In another example, the script 405 can be stored in the storage device 19a of the application search engine server 100b to be transmitted to the third module (or program) 406 when app 1 is being analyzed.

The virtual machine 400 can further include a fourth module (or program) 408 configured to store application data in the database 888 or the storage device 19a (or any other storage device(s) coupled with the application search engine server 100b).

Another embodiment of the invention can be described as follows. App 1 is executed on a virtual machine 400 by a second module (or program) 404. A third module (or program) 406 in the virtual machine 400 performs an analysis on app 1. Subsequently, a script 450 is executed to generate an activity on app 1. The activity involves requesting data from the application server 200. The application server 200 delivers the requested application data to app 1. The delivered data is collected and stored in a database 888. Furthermore, app 1 may create application data by itself. Any application data created by the application is also collected and stored in database 888. Therefore, application data collected and stored by the application search engine can be data transmitted from application server 200 as well as data generated by app 1 itself. A remote user 20 inputs a query in a field 502 and presses a search button 522 on a user interface 131a to generate a search request for data relevant to the keyword. An application search engine 600, after receiving the search request, searches for application data in the database 888 that is relevant to the query. If relevant data is found, the application search engine 600 generates a search result that includes either such data, list of relevant apps, one or more links to the one or more relevant apps associated with such data, or one or more download links for the one or more application packages of the one or more relevant apps. Subsequently, the web application 500 transmits the search result to the remote user 20.

In the embodiment described above, the application search engine 600 can search the data by string search. The data can be stored in a suffix tree, and the suffix tree can be built in the database 888. Those skilled in the art understand that the suffix tree is not the only algorithm or method to store and search data in the database.

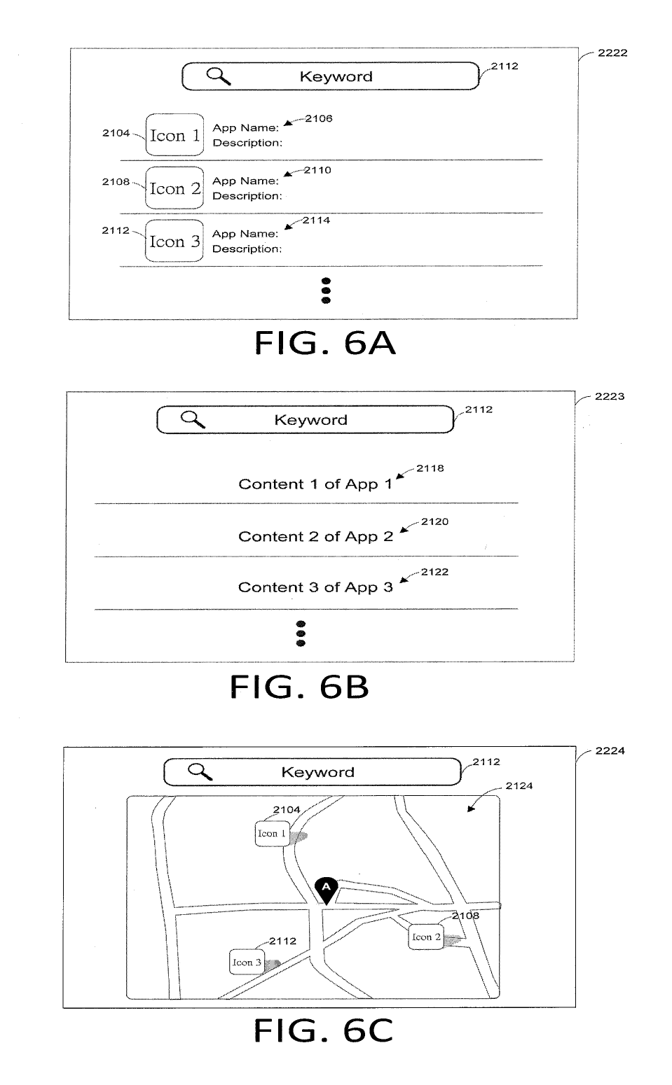

FIGS. 6A-6C illustrate some exemplary search results. Where more than one relevant application data is found by the application search engine 600, the links to the application data, the download links to the associated apps that contain such application data or the application data itself can be shown according to the number of downloads, likes or check-ins for each of the apps. The number of downloads, likes or check-ins for each app can be stored in the database 888 (referring to FIG. 3A or 3B), and the application data from the application server can also be stored in the storage device 19a for the application search engine 600 to search.

FIG. 4B illustrates another network embodiment of the present invention. The network in FIG. 4B is similar to the one in FIG. 4A except that the virtual machine 400 can be configured in a mobile OS simulating server 100e, which is separate from the application search engine 600 that is now configured in the application search engine server 100b. In another example, by using a plurality of servers configured as a single mobile OS simulating server 100e (hereinafter the “plurality of mobile OS simulating servers”), one can achieve better performance when executing multiple apps or processing a large amount of data from multiple application servers.

In still another example, to enhance system response time or load balance, the web application 500 can be configured inside the web application server 100a. The web application 500 is separated from the application search engine 600 which is configured inside the application search engine server 100b. In order to effectively serve a large amount of users, a plurality of servers can be configured as a single web application server 100a (hereinafter the “plurality of web application servers”) or as a single application search engine server 100b (hereinafter the “plurality of application search engine servers”). A load balance server (or a plurality of load balance servers) can be applied before the plurality of web application servers or the plurality of application search engine servers to better handle user's search requests. To achieve more efficient storage volume and quicker response time for accessing/searching a storage device(s) or database(s), the storage device 19a of the application search engine server 100b in FIG. 4A can be replaced with a storage device 19x disposed outside the application search engine server 100b (but still coupled to the application search engine server 100b). the storage device 19x can have larger capacity than the embedded storage device 19a of the application search engine server 100b in FIG. 4A. In another example, a plurality of storage devices (e.g., an array of storage devices), each of which is configured as the storage device 19x, can provide more capacity for the mobile OS simulating server 100e or the application search engine search server 100b. In other example, the storage device 19x can also be configured in the file management server 100d.

Similarly, the database 888 in FIG. 4A can be replaced with the database 888′ in FIG. 4B. The database 888′can couple to a database management server or a storage device 19x. In other example, a plurality of database configured as database 888′ can be used as a single database 888′ for quicker response time.

FIG. 4C illustrates another network embodiment of the present invention. The application package can be installed on a computing device 5000 with a mobile OS environment to run app 1. Alternatively, the computing device 5000 can include a computer operating system environment to host applications such as web apps, extensions and plug-ins. In one example, either app 1 can request application data from the application server 200 or app 1, ran by first user 10, can generate application by itself. The resulting application data is collected by the application search engine server 100b. The application data collected can be stored in the storage device coupling to the application search engine server 100b. In one example, the computing device 5000 can be a smart-phone 10a, a tablet (or a “pad”) 10b, a laptop 10c or a personal computer 10d.

In another example, the application search engine server 100b can further include a virtual machine 400 which comprises the module/program 404 to activate app 1 (or application) on the computing device 5000. In another example, the virtual machine 400 can also comprise a module/program 406 that runs a script 405 to execute the app 1 (or application) on the computing device 5000. The script 405 can be stored in the storage device or embedded in the module/program 406. The module/program 406 can also be configured to store the application data in the storage device 19a or other storage device coupled to the application search engine server 100b

FIG. 4D illustrates another network embodiment of the present invention. The application server 200 or the first user 10 can be configured to transmit application data directly to the application search engine server 100b, and the application search engine server 100b will store the data in the storage device 19a or other storage device. In another example, the application server 200 can transmit application data directly to a storage device and the application data will be stored in such a storage device. The application search engine server 100b can then search the storage device for data that is relevant to any query.

The embodiment illustrated by FIG. 4D does not require executing either an app or an application to obtain application data from the application server. For example, a program can be implemented to direct application server 200 to transfer or provide the application data it possesses to a storage device of the present invention. The program can be a script or any software codes that can communicate with the application server 200. The application data in the application server 200 can be transferred continuously or periodically. Once a user query is received, the application search engine server 100b can search the storage device for data that is relevant to the query. One skilled in the art understands that the present invention is not limited to the examples disclosed herein. There are other ways to collect data in the application server 200 without the need to execute the app and they should fall under the scope of the present invention.

In the embodiment above, a data harvest module or framework 3000 (see FIG. 4E) can also be implemented in the application search engine server 100b to analyze and process application data that are being transferred directly from the application server 200. Such data harvest framework can simulate the functions of an app or application in order to process and understand the application data provided by the application server 200. For example, if application data transferred by application server 200 are in discrete packets, the data harvest framework may collect the data packets and process them into meaningful application data capable of being searched. In addition, the data harvest framework also can but not limited to analyze application data to identify desired application data, exclude undesired application data, and categorize application data or a combination thereof.

The program/module/framework(s) described herein can be executed in a processor of the abovementioned server(s) (e.g., the processor 18 of the application search engine server 100b) and a process or temporary data of the program/module(s) can temporarily be stored in a cache of the processor or memory of the server(s) (e.g., the memory 12 of the application search engine server 100b). However, one skilled in the art understands that the present program/module(s) can also be implemented in hardware (e.g., a hardware module), such as a chip or a circuit.

### Crawler/Spidering

In one example, a web crawler (or a web spider) can be used to collect app or application links. Application search engine server 100b or OS simulating server 100e can download the apps or applications collected by the web crawler and run them on the server cluster 100.

### Information Retrieval

Information retrieval can be applied to application data provided by the application server in response to app or application requests. The purpose is to organize and index data into meaningful categories in order to achieve search efficiency.

### App Browser

An app can be executed on remote servers or cloud, and application data from the application server may be streamed to the client and shown on an App browser. A user may operate the apps via the App browser without the need to install the apps locally.

### An Exemplary Application

FIGS. 5A to 5E illustrate exemplary user interfaces of an app according to the present invention. In FIG. 5A, the app has an opening screen (or activating or preloading page) 988 which usually includes a picture. The opening screen 988 can be shown after the application is executed or opened.

Referring to FIGS. 5B-5E, the user interface can include the container 900 of which content(s) shown on the container 900 can be changed depending on which tab is selected (the tabs can be shown at the bottom part of the container 900 as tabs 918, 920, 922 and 924). FIG. 5B shows a layout of the container 900 when the tab 918 (i.e., the tab named “Item”) is selected. The layout can include an action bar or banner 926 (which can further include a link for a user to login to the app), a background or advertisement 910 (e.g., a video, an animation, a sliding background of a flash). Items 90-1 to 90-5 can include optional images 90-1p to 90-5p. In one example, the items 90-1 to 90-5 couple to a web application server to fetch dynamic, real-time information/data from the application server by http methods (e.g., “POST” or “GET” method such as “POST http://example.com/apiPurpose.php” or “GEThttp://example.com/apiPurpose.php?mode=GetData&ID=C00001”). Here, when the app requests information/data from the application server, the application server can transmit a response in JavaScript Object Notation (JSON) structure or eXtensible Markup Language (XML) structure (e.g., {“status”:“OK”, “result”: {“name”: “Happy Cafe”, “display”: “1”, “addr”: “3F., No. 18-6, Jinhua St., Taipei, Taiwan, R.O.C”, “desc”: “This is the Introduction of Happy Cafe”, “shophours”: “0800-2200”, “openweek”: “0111110”, “shoptel” “886-33433997”, “shopurl” “http://anotherexample.com”, “shopimage”: [{“http://example.com/images/90-1p.jpg”}]}}).

Referring to FIG. 5C, when the tab 920 (i.e., “Map”) is selected, the container 900 displays a map 988. Referring to FIG. 5D, the container can include a QR code (Quick-Response code) 999 to scan the QR code to download specific app to the mobile devices. The container 900 may further include a button 928 (named “Share to”) to allow user to share app to his/her friend(s).

Referring to FIG. 5E, the container 900 can also display messages, for example, 90a to 90d. Further, the container 900 can include an input field 912 to allow user to enter messages and a button 916 to submit the messages. Moreover, one can press a button 914 to make a private message (e.g., only a specific user(s) can see the private message after dropping the message).

### Exemplary User Interfaces Provided by Application Search Engines

FIGS. 6A to 6C illustrate another exemplary user interfaces provided by the web application server 100a or the application search engine server 100b to a user (e.g., the second user 20). The user interfaces shown in FIGS. 6A to 6C can be on a screen of a computing device such as a computer, a laptop, a tablet/pad, a smartphone or other mobile devices. Application search engine service can be accessed by touching a screen (numbered 2222, 2223 or 2224) if the screen is a touch screen, or by a cursor or a keyboard to input a keyword into the field 2112 or to select predetermined categories. Once a user selects at least one of the predetermined categories, the application search engine 600 can search data relevant to the selected category. In one example, once the string corresponding with the selected category is found, the application search engine 600 can further find the file corresponding with the string. The string can be a link or a file path pointing to the location of the file in the storage device. In another example, voice input is another way to query. Referring in FIG. 6A, apps relevant to the keyword can be shown with corresponding application icons 2104, 2108 or 2112 and application names or descriptions 2106, 2110 or 2114 as search results. Referring to FIG. 6B, the search results can be displayed as a list of app contents 2118, 2120 or 2122 or as links to those contents. Referring to FIG. 6C, the search results can also be displayed on a map 2124. The application icons 2104, 2108 and 2112, as search results, can be shown on the map 2124.

### Web Apps, Extensions and Plug-Ins

Since web apps, extensions and plug-ins (applications) operate in a similar way to apps, the present invention also discloses a method of searching applications. When running applications on a personal computer, users of these applications communicate with designated application servers while carrying out their tasks. For example, when using “The Weather Channel” extension for Chrome browser, the extension obtains user's location (or the user can input his/her location). Subsequently, application server, in conjunction with “The Weather Channel” extension, will deliver the weather forecast for the user's location or the user's choice of location to the user's browser on the computer. The mechanism here is very similar to how users of apps request data from the application server.

Accordingly, the present invention discloses another method of searching applications. The method includes the step of executing at least one application. The application may be executed in an environment on which it was intended to run or on a virtual machine. When the applications are executed, corresponding application data is generated. Application data can be received from corresponding application server and/or created by the application itself. The application data can be static or dynamic based on how the application operates. The application data can be stored in a storage device such as a database or a memory of the present system. Interface, such as a web search field, can then be provided to allow users to input their search queries. When a user query is received, a search is conducted to identify application data relevant to the queries. If relevant application data are identified, information regarding the applications corresponding to those relevant application data is transmitted to the querying user.

One skill in the art understands that the search method associated with the application is similar to the search method in the context of the apps, which was described in detail previously. Therefore, all the embodiments, methods, systems and components relating to apps apply to applications.

1. A system for searching for software applications, comprising:
one or more software applications;
one or more servers configured to execute the one or more software applications;
one or more databases;
one or more computer programs configured to collect application data from the one or more software applications and to store the collected application data in the one or more databases;
one or more search engines configured to provide search services for searching for software applications using the application data collected and stored in the one or more databases; and
a network that provides communication between various components of the system.

2. The system of claim 1, wherein the one or more computer programs further comprises an analysis module configured to analyze the one or more software applications to determine ways of collecting the application data from the one or more software applications.

3. The system of claim 2, wherein the one or more computer programs further comprises an execution module capable of executing the one or more software applications according to results from the analysis module.

4. The system of claim 1, wherein the one or more computer programs further comprises a robot module configured to simulate user behaviors to execute the one or more software applications to generate the application data.

5. The system of claim 1, wherein the one or more servers further comprises one or more virtual machines for running the one or more software applications.

6. The system of claim 1, wherein the one or more search engines are configured to receive search queries from users via the network.

7. The system of claim 1, wherein the one or more search engines are configured to generate search results ranked by search ranking logic.

8. The system of claim 1, further comprising one or more web crawlers configured to download software applications or the application data to the one or more servers via the network.

9. The system of claim 1, further comprising one or more application browsers configured to stream the application data to users.

10. The system of claim 1, further comprising one or more application servers capable of receiving and/or transmitting the application data to the one or more software applications via the network.

11. The system of claim 10, wherein the application data is generated by the one or more application servers.

12. The system of claim 10, wherein the one or more computer programs is configured to direct the one or more application servers to provide the application data without having to execute the one or more software applications.

13. The system of claim 1, wherein the application data is generated by the one or more software applications.

14. The system of claim 1, wherein the application data comprises links to the software applications, downloadable links to application package of the software applications, texts, images, videos or audios relating to the software applications or a combination thereof.

15. The system of claim 1, wherein the one or more computer programs is configured to direct the one or more software applications to provide the application data without having to execute the one or more software applications.

16. The system of claim 1, wherein the one or more computer programs further comprises one or more indexing means that organizes the application data in the one or more database.

17. The system of claim 1, further comprising a web application server that provides web related utilities, wherein the web related utilities comprises interfaces for query input and result display.

18. A system for searching for software applications, comprising:
one or more software applications;
one or more databases;
one or more computer programs configured to collect application data from the one or more software applications and to store the collected application data in the one or more databases;
one or more search engines configured to provide search services for searching for software applications using the application data collected and stored in the one or more databases; and
a network that provides communication between various components of the system.

19. The system of claim 18, wherein the collected application data comprises one or more links.

20. The system of claim 19, wherein the one or more links are hyperlinks, url and/or ip addresses.

21. The system of claim 19, further comprising one or more remote servers to which the one or more links points.

22. The system of claim 20, wherein the one or more search engines is further configured to search the one or more remote servers for software applications.

23. The system of claim 20, wherein the one or more computer programs is further configured to collect application data from the one or more remote servers.

24. A system for searching for software applications, comprising:
one or more software applications;
one or more databases;
one or more application servers capable of receiving and/or transmitting application data to the one or more software applications;
one or more computer programs configured to collect the application data from the one or more application servers and to store the collected application data in the one or more databases;
one or more search engines configured to provide search services for searching for software applications using the application data collected and stored in the one or more databases; and
a network that provides communication between various components of the system.

25. The system of claim 24, wherein the one or more software applications comprises one or more links pointing to the one or more application servers.
